(19) United States
(12) Patent Application Publication
(10) Pub. No.: US 2012/0251025 A1
(43) Pub. Date: Oct. 4, 2012

(54) ANGULAR CONTACT BALL BEARING, IN PARTICULAR A SPINDLE BEARING, HAVING IMPROVED CAGE GUIDANCE

(75) Inventors: Christoph Haizmann, Schweinfurt (DE); Otmar Hartling, Schonungen (DE); Volker Kestler, Schweinfurt (DE); Norbert Kretzer, Schweinfurt (DE); Manuel Lommel, Grettstadt (DE); Horst Masuch, Schweinfurt (DE); Wolfgang May, Himmelstadt (DE)

(73) Assignee: SCHAEFFLER TECHNOLOGIES AG & CO. KG, Herzogenaurach (DE)

(21) Appl. No.: 13/503,047

(22) PCT Filed: Sep. 21, 2010
(86) PCT No.: PCT/EP10/63834

§ 371 Date: Jun. 21, 2012

(30) Foreign Application Priority Data
Oct. 21, 2009 (DE) 10 2009 050 153.3

(51) Int. Cl. F16C 33/58

(52) U.S. Cl. 384/513

(57) ABSTRACT

An angular contact ball bearing, which has an outer ring, an inner ring, and a plurality of balls arranged between the outer ring and the inner ring in a cage rotatably about a bearing axis. The cage is guided via a cage guiding surface of the outer ring. The angular contact ball bearing has a nominal pressure angle of less than or equal to 30 degrees. In a sectional view, a circular arc runs from a point of a track of the outer ring furthest away from the bearing axis along the track in the direction of a track end facing the cage guiding surface to an intersecting point of the circular arc a straight line through the cage guiding surface has a central angle that is greater than or equal to 60 degrees.

### FIELD OF THE INVENTION

The invention relates to an angular contact ball bearing, comprising an outer ring, an inner ring, a plurality of balls, the balls being arranged between the outer ring and the inner ring in a cage such that they can rotate about a bearing axis, the cage being guided via a cage guidance face of the outer ring, and the angular contact ball bearing having a nominal contact angle of less than or equal to 30 degrees.

Angular contact ball bearings of this type are used, for example, as spindle bearings in machine tools, said bearings often being designed for high rotational speeds, for example over 15 000 revolutions/minute. It is precisely in said fast-running antifriction bearings that it has proved advantageous that the cages are not guided by rolling body, but rather on the shoulders or rims of a bearing ring, in general cage guidance faces. Here, they are what are known as rim-guided cages. In this way, problems with regard to the friction of the rolling bodies in the pockets are avoided, since the play of the rolling bodies in the cage pockets can be selected to be sufficiently great.

A generic angular contact ball bearing of this type is shown in FIG. 1, The angular contact ball bearing 1 comprises an inner ring 2 with an inner ring raceway 3, an outer ring 4 with an outer ring raceway 5 and balls 6 which are guided by a cage 10 and roll about a bearing axis 7 on the inner ring raceway 3 and the outer ring raceway 5. The outer ring 4 has a rim 8 with a cage guidance face 9 which lies opposite a radially outwardly facing surface 11 of a ring element of the cage 10. The cage 10 is guided by its surface 11 and the cage guidance face 9 of the outer ring 4. The nominal contact angle a (alpha) is 25° in this example, Here, the nominal contact angle denotes the angle which a contact line encloses with a radial plane in the case of an unloaded hearing, that is to say in the case of a bearing, in which the balls make contact with the raceways without stress.

It has been shown that friction occurs to a considerable extent between the surface 11 of the cage and the cage guidance face 9 of the outer ring 8 during operation. The friction gains influence, in particular, as the bearing rotational speed increases.

### OBJECT OF THE INVENTION

The invention is based on the object of providing a generic angular contact ball hearing which brings about a reduction in the friction between the cage and the outer ring with the balls continuing to be guided reliably, and which can be produced simply and inexpensively.

### SUMMARY OF THE INVENTION

This object is achieved by an angular contact ball bearing in accordance with the independent claim. According to the latter, a generic angular contact ball bearing is distinguished by the fact that, in a sectional illustration, enclosing the bearing axis, a circular arc has a central angle of greater than or equal to 60 degrees, said circular arc extending from a point of a raceway of the outer ring, which point is the furthest away from the bearing axis, along the raceway in the direction of a raceway end, which faces the cage guidance face, as far as a point of intersection of the circular arc and a straight line laid through the cage guidance face.

The invention is based on the concept of achieving a reduction in the friction between the cage and the outer ring by a reduction in the cage mass. It has thus been recognized that the cage mass has a substantial influence on the friction via the centrifugal force, in particular at very high rotational speeds, since the contact force between the cage and the outer ring increases greatly with the rotational speed.

The solution according to the invention then lies in the fact that the cage mass and therefore the friction can be reduced significantly, by the cage guidance face of the outer ring being displaced further in the direction of the bearing axis. Here, the fact is utilized that the function of the cage can in principle already be fulfilled by a cage which has a considerably smaller external diameter in comparison with the cages according to the prior art, for example FIG. 1. It is thus sufficient for the function of the cage, namely bringing about a spacing of the balls, to have only a comparatively small radial extent on both sides of the pitch circle. According to the invention, the cage guidance face of the outer ring is then to be pushed inward radially with respect to the bearing axis to such an extent that the radial extent of the cage is determined exclusively by the requirements of its function, that is to say the spacing of the balls.

It is not decisive for the realization of the core concept of the invention in which way the cage guidance face of the outer ring is displaced radially in the direction of the bearing axis, As explained in the following text, an enlargement of the rim, in particular, is conceivable, including an extension of the raceway and separate radial projections which are formed on the rim, enclosing the cage guidance face. Radial projections of this type can either be part of a single piece rim or outer ring or else can be formed by separate ring elements which are pushed onto the rim of the outer ring.

According to the invention, the radial displacement of the cage guidance face is defined in such a way that a circular segment which begins at a point of the raceway, which point is the furthest away from the bearing axis, extends along the raceway in the direction of a raceway end which faces the cage guidance face, and ends at a point of intersection of the circular segment with a straight line which extends through the cage guidance face, exceeds a defined central angle. Here, the central angle defines, as customary in geometry, the angle which two end points of a circular segment enclose with the center point of the circular segment, The greater the central angle of the circular segment according to the invention, the further the cage guidance face is displaced radially to the inside, that is to say toward the bearing axis. In particular, according to the invention, the central angle is to assume an angle of 60° or more. Above this value, firstly a discernible reduction in the friction is produced, and secondly the cage can continue to extend sufficiently radially to the outside, starting radially from the pitch circle, in order to guide the balls reliably.

Although outer rings having a rim which reaches radially to the inside to such an extent that a correspondingly defined central angle assumes a value of over 60 degrees are already known, outer rings of this type are provided for use in angular contact ball bearings having a nominal contact angle of 40 degrees or more. A rim of this type is necessary for bearings of this type which are otherwise not used as spindle bearings, but rather as bearings for low rotational speeds, in order to form a corresponding raceway for the high contact angle. In contrast, the outer ring according to the invention is an outer ring of an angular contact ball bearing having a nominal contact angle of 30 degrees or less.

Preferred embodiments of the invention are specified in the subclaims.

According to one embodiment, the inner ring has two shoulders which are mirror-symmetrical with regard to a plane which lies perpendicularly with respect to the bearing axis. Here, the two shoulders of the inner ring are of symmetrical configuration at least with regard to their basic shape. In particular, the two shoulders are to have an identical height, that is to say both shoulders have a radially outwardly directed end face, the spacing of which from the bearing axis is identically great. A construction of this type has the advantage that identical sealing washers can be used on both sides in a sealed bearing.

Low-mass and, moreover, simple constructions of the cage are made possible by the design according to the invention of the outer ring, that is to say of the positioning of the cage guidance face.

Thus, according to one embodiment, the cage has two ring elements and transverse webs, which connect the ring elements, the transverse webs terminating flushly with the ring elements radially to the inside and/or radially to the outside. The ring elements extend around the bearing axis and are arranged concentrically with respect to one another. The ring elements preferably have the same internal and external diameters; in particular, the cross-section of the ring elements can be identical. Whereas, according to the prior art, at least one ring element has been extended radially to the outside in the direction of the cage guidance face, in order to ensure reliable and precise guidance of the cage, an extension of this type can be omitted according to the invention.

Rather, the two ring elements no longer have to extend beyond the maximum required radial extent of the transverse webs. In particular, the cage can have an annular shape with a rectangular cross-sectional profile, which annular shape has cage pockets for receiving the balls. Starting from the pitch circle, that is to say a circle through the center points of the balls, the cage preferably has a substantially identically great extent in both radial directions.

In addition to a weight reduction, the design according to the invention of the cage also makes a simplification of the cage production possible. Thus, according to a further embodiment, the cage can be of mirror-symmetrical configuration with regard to a plane which lies perpendicularly with respect to the bearing axis. A symmetrical cage shape of this type makes simpler production and simpler assembly of the angular contact ball bearing possible and results from the fact that, according to the invention, the cage design is predefined substantially only by the function of the spacing of the balls.

According to a further embodiment, the cage has two ring elements which extend concentrically with respect to the bearing axis and transverse webs which connect the ring elements, the cage being guided by the cage guidance face of the outer ring via a radially outwardly facing surface of one of the ring elements. An annular gap is therefore formed between the cage guidance face of the outer ring and the surface of the cage.

Here, both the cage guidance face and the surface of the cage expediently extend parallel to one another along the bearing axis. In particular, according to one embodiment, the cage guidance face forms a cylinder which is arranged concentrically around the bearing axis. In a corresponding way, that surface of the cage which lies opposite the cage guidance face likewise forms a cylinder which is arranged concentrically around the bearing axis. A cylindrical annular gap is therefore formed between the cage guidance face and the surface of the cage. It goes without saying that different profiles of the faces, for example a conical profile, would also be conceivable in principle.

According to one embodiment, the central angle lies between 60 and 70 degrees. The central angle preferably lies between 63 and 67 degrees. It has been shown that a good compromise can be achieved in these ranges between a reduction in the friction by a decrease in the radial extent of the cage firstly and maintenance of reliable and precise guidance of the balls by a sufficient radial extent of the cage secondly if transverse webs and ring elements of the cage are to terminate radially flushly.

According to one embodiment, the nominal contact angle lies between 15 and 25 degrees. The nominal contact angle is preferably 15 or 25 degrees, These two values are typical values for spindle bearings, that is to say standardized inner rings can be used.

According to one embodiment, the raceway has a point of intersection with the cage guidance face in the sectional illustration. According to this embodiment, the rim of the outer ring has therefore been enlarged radially toward the bearing axis, that is to say the rim is configured to be higher than is known from the prior art, but in principle has the same basic shape as previously. The point of intersection between the raceway and the cage guidance face can be rounded. As an alternative, however, it is also possible that, in the sectional illustration, a shoulder or a step is made between the raceway and the cage guidance face according to one embodiment. Instead of an enlargement of the rim in the direction of the bearing axis with a simultaneous extension of the raceway likewise in the direction of the bearing axis, a radially inwardly directed projection is formed on the previous rim according to this exemplary embodiment, The cage guidance face is situated on a radially inwardly directed surface of the projection. Here, the raceway can remain unchanged, with the result that a step is produced between the projection and the raceway. Here, the radial extent of the projection or the step represents the radial displacement of the cage guidance face, It is then conceivable that this projection is an integral element of the rim or outer ring or else is formed by a separate element. If the projection is an integral element of the rim or outer ring, the outer ring can be, in particular of single piece configuration according to one embodiment. If the projection is formed by a separate, element, this can consist, for example, of a ring element with a rectangular cross section profile which is introduced into the outer ring. Here, the separate element can be composed of the same or a different material as the outer ring. The option of it continuing to be possible to use outer rings which already exist is advantageous in the case of a separate element.

The reduction according to the invention in the friction does not require an increase in the installation space of the angular contact ball bearing, neither axial nor radial installation space. Thus, according to one embodiment, the inner ring and the outer ring have an identically great axial extent. Here, said extent corresponds to the value of corresponding standard angular contact bail bearings.

According to one embodiment, the angular contact ball bearing is sealed at one or at two axial ends. Here, a sealing washer can be inserted in each case at the axial ends of the angular contact ball bearing between the inner ring and the outer ring.

The angular contact ball bearing according to the invention is suitable, in particular, for being used as a spindle bearing, for example of a machine tool. However, it goes without saying that other applications are also conceivable, in particular as antifriction bearings for high speeds.

### BRIEF DESCRIPTION OF THE DRAWINGS

Exemplary embodiments of the present invention will be described in greater detail in the following text using the appended figures, in which:

FIG. 1 shows an angular contact ball bearing according to the prior art,

FIG. 2 shows a first exemplary embodiment of an angular contact ball bearing according to the invention,

FIG. 3 shows a second exemplary embodiment of an angular contact ball bearing according to the invention, and

FIG. 4 shows a machine tool, comprising an angular contact ball bearing according to the invention.

### DETAILED DESCRIPTION OF THE DRAWINGS

Identical or functionally identical components in the figures are provided with identical designations.

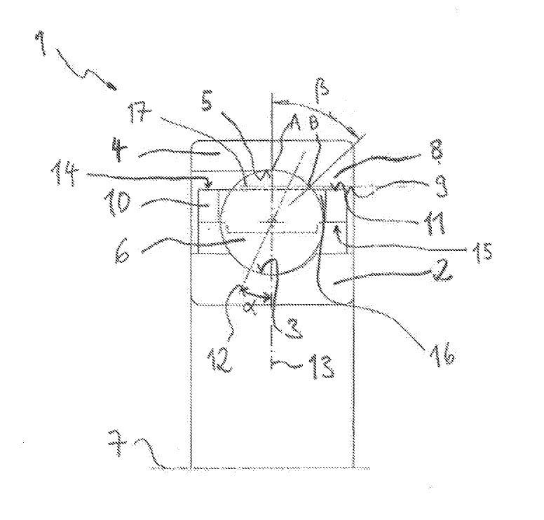

FIG. 1 shows an angular contact ball bearing according to the prior art, as described in the introduction, in a sectional illustration, enclosing the bearing axis 7, the upper half being shown. The contact line 12 for the unloaded bearing is shown and forms the nominal contact angle α (alpha), which is 25 degrees in this example, with a plane 13, a radial plane, which lies perpendicularly with respect to the bearing axis 7,

The outer ring raceway 5 has a point A, which is the furthest away from the bearing axis 7. The result of starting from point A along the outer ring raceway 5 in the direction of that end of the outer ring raceway 5 which faces the cage guidance face 9 as far as a point of intersection B of the outer ring raceway 5 with a straight line 17 laid through the cage guidance face 9 is a circular segment, the central angle β (beta) of which is approximately 50 degrees in this example. That is to say, the nominal contact angle a (alpha) is approximately half as great as the central angle β (beta).

The cage of the angular contact ball bearing according to FIG. 1 consists of two ring elements 14, 15 which extend circumferentially and are connected by a plurality of axially extending transverse webs 16. The transverse webs 16 have guidance faces for making contact with the balls 6, it being possible for the balls to be composed of metal or ceramic. For optimum guidance of the balls, it is necessary that said guidance faces extend radially both outside and inside a pitch circle through the ball center point of the angular contact ball bearing 1.

In order to make guidance of the cage 10 by way of the rim 8 of the outer ring 4 possible, the cage 10 extends radially correspondingly far to the outside. In particular, starting from the pitch circle, the cage 10 extends substantially further radially to the outside than radially to the inside.

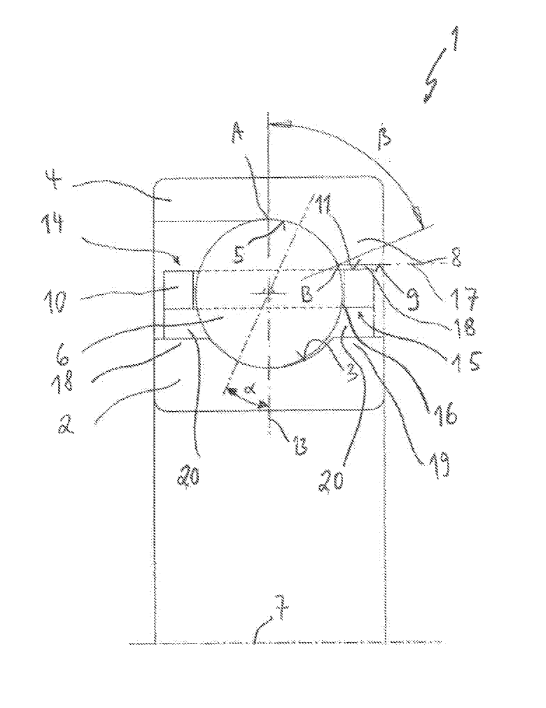

FIG. 2 shows a first exemplary embodiment of an angular contact ball bearing according to the invention. In contrast to the angular contact ball bearing according to the prior art in accordance with FIG. 1, in FIG. 2 the rim 8 of the outer ring 4 has been extended considerably radially to the inside, that is to say radially toward the bearing axis 7. It has been possible to shorten the radial extent of the cage 10 by the same amount, An annular gap 18 is situated between the cage guidance face 9 and the surface 11.

On that side of the outer ring 4, which lies axially opposite the rim 8, the outer ring 4 has only a small radial projection in the direction of the bearing axis 7, in order to prevent the balls 6 falling out. However, no cage guidance face is situated on this side, that is to say the cage 10 is guided only by a single cage guidance face 9.

The cage guidance face 9 has been displaced in the direction of the bearing axis 7, by the complete rim 8 having been enlarged toward the bearing axis 7. In particular, the outer ring raceway 5 has also been enlarged correspondingly here.

The central angle β (beta) is 68 degrees, The nominal contact angle α (alpha) has not been changed, that is to say it is still 25 degrees. The novel construction of the rim and of the cage does not lead to any change in the rolling behavior of the balls 6 on the corresponding raceways 3, 5, with the exception that a lesser development of heat is achieved on account of the reduced friction.

It has been possible to restrict the radial extent of the cage 10 to a minimum. In a section enclosing the bearing axis 7, said cage 10 has a rectangular cross section. Each of the two ring elements 14, 15 likewise has a rectangular cross-section and terminates radially flushly with the transverse webs 16. The cage 10 is mirror-symmetrical with regard to a radial plane 13.

The outer ring 4 and the inner ring 2 have the same axial extent and terminate axially flushly. In particular, the external dimensions of the angular contact ball bearing 1 correspond to those of a comparable standard bearing.

The inner ring 2 has two rims 18, 19 which extend radially to the outside by the same amount. In particular, both rims 18, 19 are mirror-symmetrical with regard to a radial plane 13. Neither of the rims 18, 19 has a cage guidance face, but rather there is a substantially greater annular gap 20 in comparison with the annular gap 18, between the cage 10 and the rims 18, 19. Said annular gap 20 makes it possible to feed in lubricant during operation.

The angular contact ball bearing 1 could be sealed by means of two sealing washers.

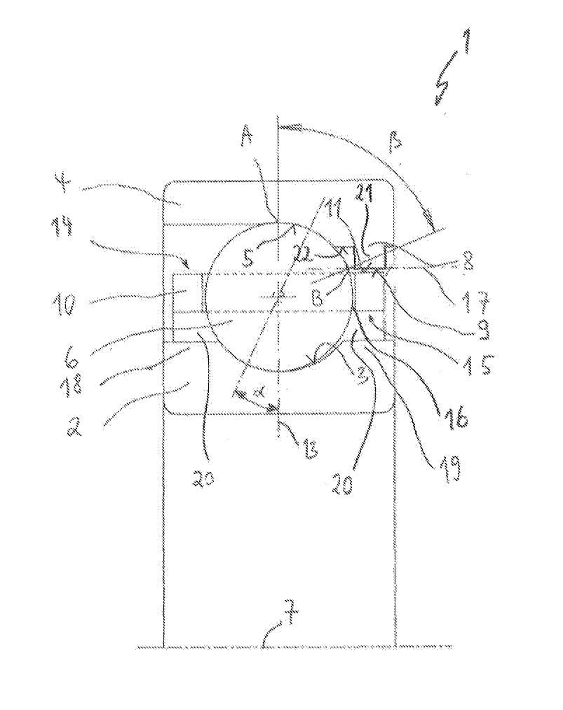

FIG. 3 shows a second exemplary embodiment of an angular contact ball bearing according to the invention. In contrast to the exemplary embodiment according to FIG. 2, according to FIG. 3 the cage guidance face 9 has been displaced radially to the inside, by the rim 8 having a projection 21. The projection 21 extends radially to the inside from a radially inwardly pointing rim surface 22 and has the cage guidance face 9. The outer ring raceway 5 remained unchanged. In this exemplary embodiment, the projection 21 is configured in one piece with the rim 8. It goes without saying that a separate ring which is fitted in the outer ring 4 onto the rim surface 22 would also be conceivable. The central angle which is defined according to the invention is 68 degrees as in the first exemplary embodiment.

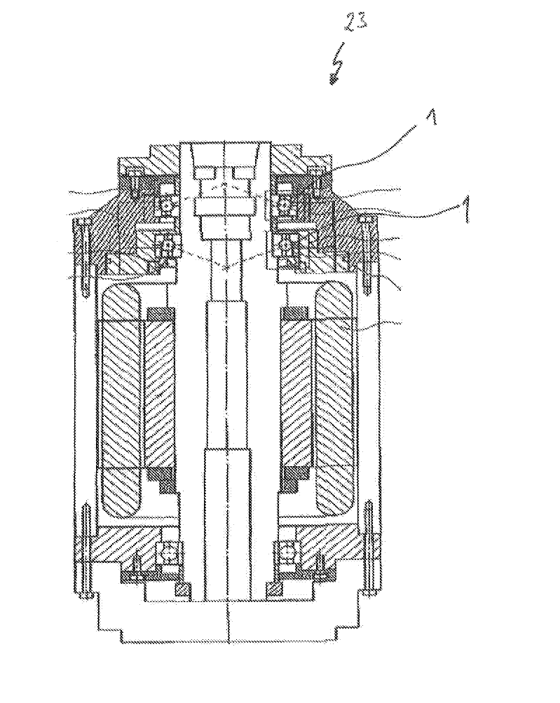

FIG. 4 shows a drive of a machine tool 23, comprising two angular contact ball bearings 1 according to the invention which are configured as spindle bearings, are inserted in an O-arrangement and serve as locating bearings.

### LIST OF DESIGNATIONS

1 Angular Contact Ball Bearing
2 Inner Ring
3 Inner Ring Raceway
4 Outer Ring
5 Outer Ring Raceway
6 Balls
7 Bearing Axis
8 Rim
9 Cage Guidance Face
10 Cage
11 Surface
12 Contact Line
13 Plane
14 Ring Element
15 Ring Element
16 Transverse Web
17 Straight Line
18 Rim
19 Rim
20 Annular Gap
21 Projection
22 Rim Surface
23 Drive, Machine Tool

1-15. (canceled)

16. An angular contact ball bearing which is rotatable about a bearing axis, comprising;
an outer ring having a raceway and a cage guidance face;
an inner ring;
a cage guided by the cage guidance face of the outer ring; and
a plurality of balls arranged between the outer ring and the inner ring in the cage such that the balls can rotate about the bearing axis,
wherein the angular contact ball bearing has a nominal contact angle of less than or equal to 30 degrees, and
wherein, as viewed in cross-section, a circular arc extends from a point of the raceway of the outer ring, which is furthest away from the bearing axis, along the raceway of the outer ring in a direction of an end of the raceway of the outer ring which faces the cage guidance face to a point of intersection of the circular arc and a straight line, which extends through the cage guidance face, the circular arc having a central angle of greater than or equal to 60 degrees.

17. The angular contact ball bearing as claimed in claim 16, wherein the inner ring has two shoulders, which are symmetrical mirror images of each other with regard to a plane which lies perpendicular with respect to the bearing axis.

18. The angular contact ball bearing as claimed in claim 16, wherein the cage guidance face forms a cylinder which is arranged concentrically around the bearing axis.

19. The angular contact ball bearing as claimed in claim 16, wherein the cage is mirror-symmetrical with regard to a plane that lies perpendicularly with respect to the bearing axis.

20. The angular contact ball bearing as claimed in claim 1.6, wherein the cage has two ring elements and transverse webs which connect the ring elements and terminate flushly at the ring elements radially to an inside and/or radially to an outside of the ring elements.

21. The angular contact ball bearing as claimed in claim 16, wherein the cage has two ring elements and transverse webs which connect the ring elements, and the cage is guided by the cage guidance face of the outer ring via a radially outwardly facing surface of one of the ring elements.

22. The angular contact ball bearing as claimed in claim 16, wherein the central angle lies between 60 and 70 degrees.

23. The angular contact ball bearing as claimed in claim 22, wherein the central angle lies between 63 and 67 degrees.

24. The angular contact ball bearing as claimed in claim 16, wherein the nominal contact angle lies between 15 and 25 degrees.

25. The angular contact ball bearing as claimed in claim 16, wherein, as viewed in cross-section, the raceway of the outer ring has a point of intersection with the cage guidance face.

26. The angular contact ball bearing as claimed in claim 16, wherein, as viewed in cross-section, a shoulder or a step is formed between the raceway and the cage guidance face.

27. The angular contact ball bearing as claimed in claim 16, wherein the outer ring is of single piece configuration.

28. The angular contact ball bearing as claimed in claim 16, wherein the inner ring and the outer ring extend axially a same distance.

29. The angular contact ball bearing as claimed in claim 16, wherein the angular contact ball bearing is sealed at one axial end,

30. The angular contact ball bearing as claimed in claim 16, wherein the angular contact ball bearing is sealed at two axial ends.

31. The angular contact ball bearing as claimed in claim 16, wherein the angular contact bail bearing is a spindle bearing.
